(19) United States
(12) Patent Application Publication
(10) Pub. No.: US 2010/0251788 A1
(43) Pub. Date: Oct. 7, 2010

(54) Safety door lock

(75) Inventor: Ching Tien Lin, Taipei Hsien (TW)

Correspondence Address: CHARLES E. BAXLEY, ESQUIRE, 90 JOHN STREET, SUITE 309, NEW YORK, NY, 10038, US

(73) Assignee: Thase Enterprise Co., Ltd.

(21) Appl. No.: 12/384,631

(22) Filed: Apr. 7, 2009

(51) Int. Cl. E05B 55/04

(52) U.S. Cl. 70/472

(57) ABSTRACT

A door lock includes an actuating lever attached to a housing and engaged with a handle shaft, a rotary member rotatably mounted to the housing and connected to the actuating lever with a slide plate and a rocker arm, a spindle rotatably engaged with the rotary member, a latch member slidably attached to the rotary member and engageable with the spindle, and a follower having an actuating finger for selectively disengaging the latch member from the spindle and for preventing the spindle from being rotated by the rotary member and the actuating lever when the door is locked, and for preventing the connecting mechanism between the dead bolt and the actuating lever from being damaged by the actuating lever brutally or forcedly.

### BACKGROUND OF THE INVENTION

1. Field of the Invention

The present invention relates to a door lock, and more particularly to a safety door lock including an actuating lever freely rotatable and disconnected from the dead bolt when the latch shaft of the lock device is locked for preventing the dead bolt and the connecting mechanism from being damaged by the actuating lever brutally or forcedly and/or from being brutally or forcedly damaged by the unauthorized persons.

2. Description of the Prior Art

Typical door locks comprise a lock device attached to a door panel for locking the door panel to a door frame, and an actuating lever coupled to a dead bolt for actuating or disengaging the dead bolt from the door frame and for opening the door panel from the door frame.

For example, U.S. Pat. No. 5,040,391 to Lin, U.S. Pat. No. 5,286,074 to Lin, U.S. Pat. No. 5,878,606 to Chaput et al., U.S. Pat. No. 5,881,585 to Kang, and U.S. Pat. No. 5,890,385 to Lee disclose five of the typical door locks each also comprising a lock device including an actuatable latch shaft for locking and unlocking a door panel from a door frame, a dead bolt slidably engaged in the door panel, and an actuating lever rotatably attached or mounted to the door panel and coupled to the dead bolt for actuating or disengaging the dead bolt from the door frame and for opening the door panel from the door frame.

However, normally, even when the door panel is locked to the door frame, or when the latch shaft of the lock device is locked to the door frame, the actuating lever is still coupled or connected to the dead bolt, and the connecting mechanism coupled or connected between the dead bolt and the actuating lever may be brutally or forcedly rotated or actuated or damaged by the actuating lever and/or by the unauthorized persons.

The present invention has arisen to mitigate and/or obviate the afore-described disadvantages of the conventional lever actuated door locks.

### SUMMARY OF THE INVENTION

The primary objective of the present invention is to provide a safety door lock including an actuating lever freely rotatable and disconnected from the dead bolt when the latch shaft of the lock device is locked for preventing the dead bolt and the connecting mechanism between the dead bolt and the actuating lever from being damaged by the actuating lever brutally or forcedly and/or from being brutally or forcedly damaged by the unauthorized persons.

In accordance with one aspect of the invention, there is provided a door lock comprising a housing including a chamber formed therein, a lock device attached to the housing, an actuating lever rotatably attached to the housing and including a noncircular orifice formed therein for engaging with a handle shaft and for rotating the handle shaft, a rocker arm engaged with the handle shaft and to be rotated and driven by the handle shaft and the actuating lever, a slide plate slidably attached to the housing and engaged with the rocker arm and moveable relative to the housing by the rocker arm, a rotary member rotatably mounted to the housing and connected to the slide plate for allowing the rotary member to be rotated relative to the housing by the slide plate and the rocker arm and the handle shaft and the actuating lever, a spindle rotatably attached to the housing and engaged with the rotary member, a latch member slidably attached to the rotary member and movable relative to the rotary member and engageable with the spindle for selectively coupling the spindle to the rotary member and for allowing the spindle to be selectively rotated by the rotary member, and a follower disposed in the housing and including an actuating finger movable toward and away from the latch member for selectively forcing and actuating the latch member to engage with the spindle and for allowing the spindle to be selectively rotated by the rotary member when the latch member is engaged with the spindle, and for preventing the spindle from being rotated by the rotary member when the latch member is disengaged from the spindle, and for disconnecting the actuating lever from a dead bolt and for preventing the dead bolt and the connecting mechanism between the dead bolt and the actuating lever from being damaged by the actuating lever brutally or forcedly.

The rotary member includes a spring member engaged between the latch member and the rotary member for biasing the latch member away from the spindle or for disengaging the latch member from the spindle.

The rotary member includes a channel formed therein, and the latch member includes a rod extended outwardly therefrom and slidably engaged with the channel of the rotary member for guiding and limiting the latch member to slide and to move relative to the rotary member.

The rotary member includes a center hole formed therein, and the spindle includes a noncircular end rotatably engaged with the center hole of the rotary member for selectively engaging with the latch member.

The slide plate includes an anchoring portion provided therein, and the rotary member includes an actuator engaged with the anchoring portion of the slide plate for connecting the rotary member to the slide plate and for allowing the rotary member to be rotated relative to the housing by the slide plate and the rocker arm and the handle shaft and the actuating lever.

The housing includes a cover plate, and a spring member engaged between the cover plate and the slide plate for biasing and forcing the slide plate to engage with the rocker arm. The follower is slidably attached to the housing and disposed in the chamber of the housing.

The housing includes at least one guide pin extended into the chamber of the housing, and the slide plate is slidably attached to the guide pin of the housing and limited to slide and to move relative to the housing by the guide pin and guided to move or to engage with the rocker arm.

The housing includes at least one stop, and the follower includes at least one slot formed therein for slidably receiving and engaging with the stop of the housing and for guiding and limiting the follower to slide and to move relative to the housing, and for guiding the actuating finger of the follower to move toward and to move away from the latch member and for selectively engaging with the latch member.

The follower includes a projection extended therefrom and coupled to the lock device with a link for allowing the actuating finger of the follower to be selectively moved relative to the housing by the lock device and to be selectively actuated to engage with the latch member.

The spindle includes a plurality of cavities formed therein for engaging with an anchor, and the anchor may be used or provided for adjustably anchoring and securing the spindle to the door panels of different thicknesses.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view illustrating an attachment of a safety door lock in accordance with the present invention to a door panel;

FIG. 2 is a partial exploded view of the safety door lock;

FIG. 3 is a rear perspective view of the safety door lock;

FIG. 4 is a rear plan schematic view of the safety door lock;

FIG. 5 is a rear plan schematic view similar to FIG. 4, illustrating the operation of the door lock;

FIG. 6 is another partial exploded view of the safety door lock;

FIG. 7 is a further partial exploded view illustrating the other arrangement of the door lock; and

FIG. 8 is a rear plan schematic view of the safety door lock as shown in FIG. 7.

### DETAILED DESCRIPTION OF THE PREFERRED EMBODIMENT

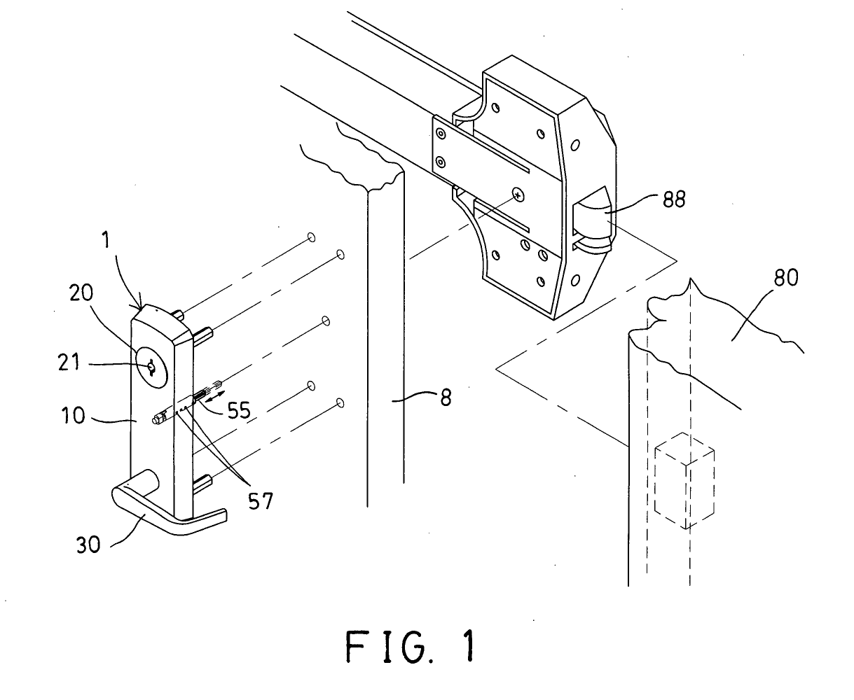

Referring to the drawings, and initially to FIGS. 1-4, a safety door lock 1 in accordance with the present invention comprises an escutcheon or outer housing 10 for attaching to a door panel 8 (FIG. 1), and including a chamber 11 formed therein, and including an exterior lock device 20 attached to the housing 10 and having a key hole 21 formed therein for receiving or inserting or engaging with a key (not shown) which may be used for locking and unlocking the door panel 8 from a door frame 80. The housing 10 includes two stops 12, 13 extended into the chamber 11 thereof and located in the upper portion of the housing 10 and located close to the exterior lock device 20, and includes an opening 14 formed therein and located in the lower portion of the housing 10, and includes one or more guide pins 15 extended into the chamber 11 from the middle portion of the housing 10.

An actuating lever 30 is rotatably attached or mounted to the opening 14 of the housing 10, and includes a noncircular orifice 31 formed therein for receiving or inserting or engaging with a handle shaft 32 and for rotating the handle shaft 32, a support plate 33 is attached or mounted to the housing 10 for rotatably and stably supporting the handle shaft 32, A rocker arm 34 includes a noncircular hole 35 formed therein for receiving or inserting or engaging with the handle shaft 32 and for allowing the rocker arm 34 to be rotated or driven by the handle shaft 32 and the actuating lever 30, the rocker arm 34 includes one or more (such as two) actuating protrusions 36 extended outwardly therefrom. The above-described structure is typical and will not be described in further details.

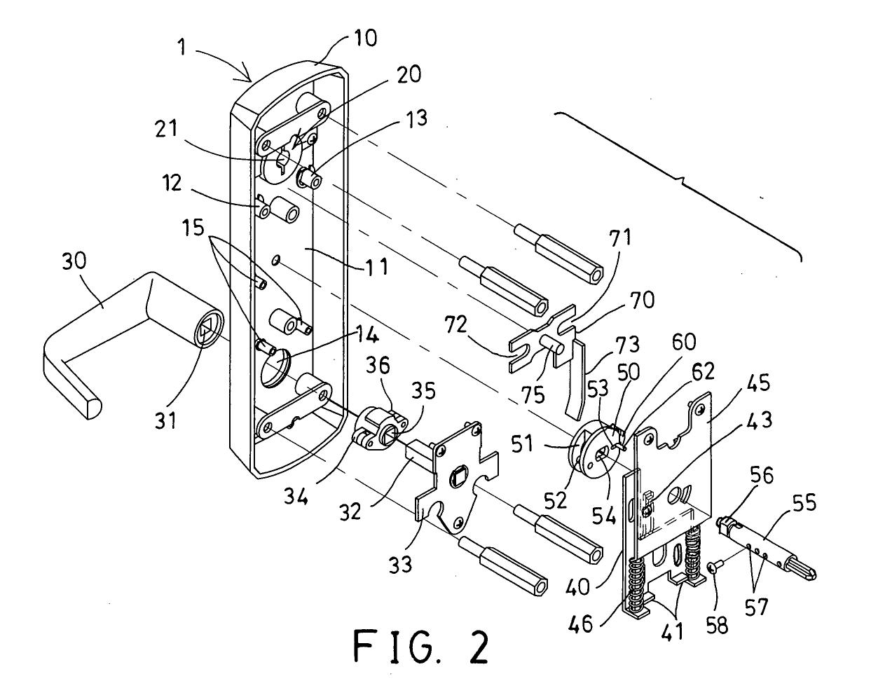

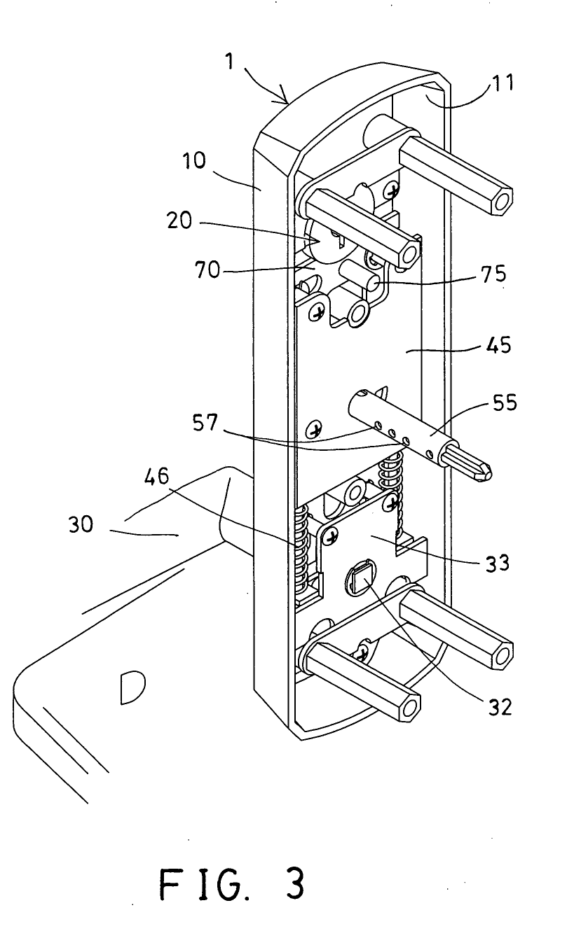

A slide plate 40 is slidably attached to the guide pins 15 of the housing 10 and limited to slide or move up and down relative to the housing 10 by the guide pins 15, and includes a bottom portion 41 rested or located above the rocker arm 34 for being actuated to slide or to move up and down by the rocker arm 34, and includes an extension 42 having an anchoring cavity or portion 43 formed or provided therein. A cover plate 45 (FIGS. 2, 3) is attached or mounted to the housing 10, such as secured to the guide pins 15 of the housing 10, and one or more spring members 46 are disposed or engaged between the cover plate 45 and the slide plate 40 for biasing or forcing the slide plate 40 downwardly toward and to engage with the rocker arm 34.

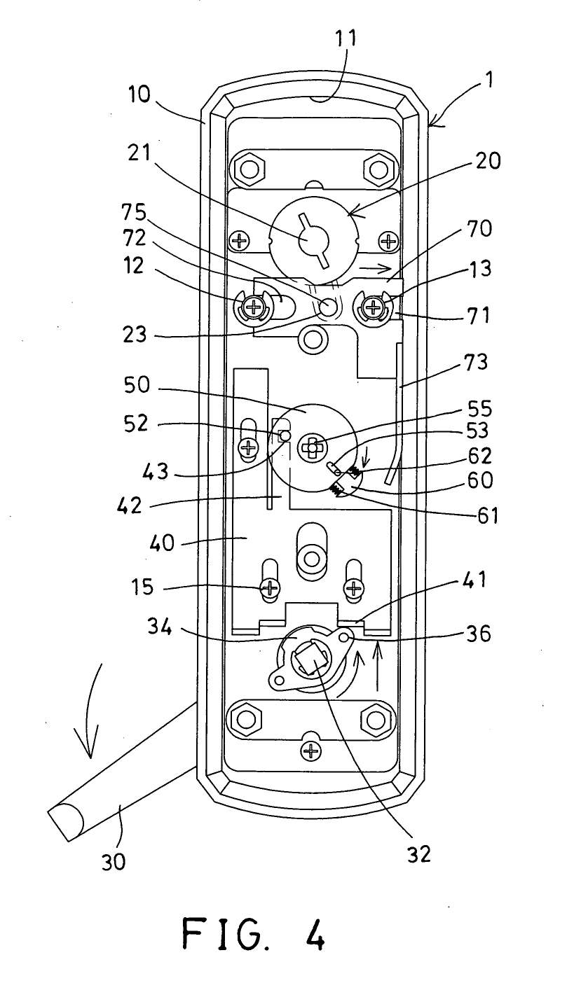

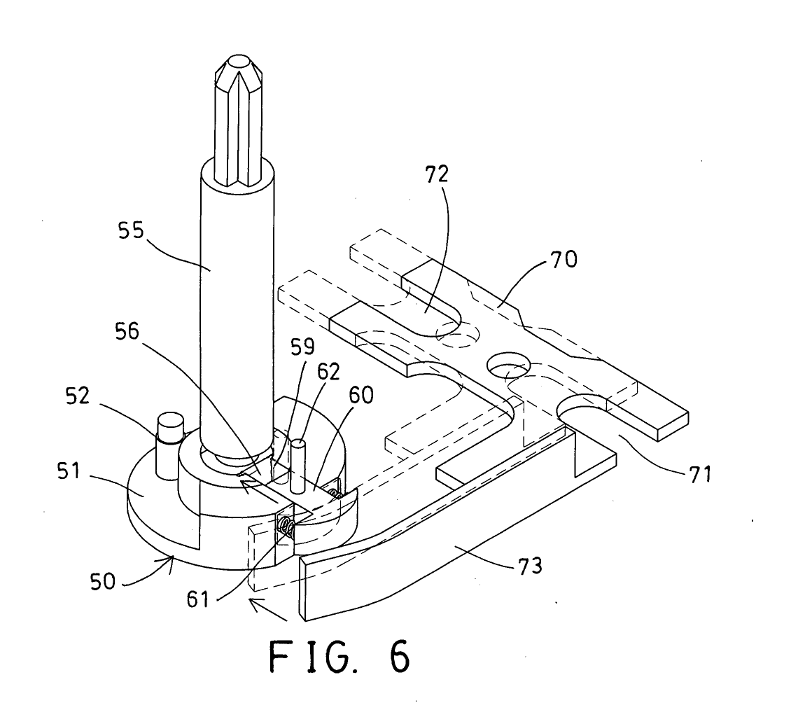

A rotary member 50 is rotatably attached or mounted to the housing 10, and disposed or engaged between the cover plate 45 and the housing 10, and includes a space 51 formed therein (FIGS. 2, 6) for receiving or engaging with the extension 42 of the slide plate 40, and includes an actuator 52 extended into the space 51 thereof and engaged with the anchoring cavity or portion 43 of the extension 42 of the slide plate 40 (FIGS. 4, 5, 8) for connecting the rotary member 50 to the slide plate 40 and for allowing the rotary member 50 to be rotated or driven relative to the housing 10 by the slide plate 40 and the rocker arm 34 and the handle shaft 32 and the actuating lever 30. The rotary member 50 may further include a channel 53 formed therein (FIGS. 2, 4, 5) and located in the outer peripheral portion thereof, and preferably extended radially relative to the rotary member 50.

A spindle 55 is rotatably engaged through the cover plate 45 and/or rotatably attached or mounted to the housing 10, and includes a noncircular end 56 rotatably engaged with a center hole 54 of the rotary member 50 for stably and rotatably supporting the rotary member 50 in the housing 10 and between the cover plate 45 and the housing 10. The spindle 55 includes two or more cavities 57 formed therein for engaging with an anchor 58 (FIG. 2) which may adjustably anchoring or securing the spindle 55 to the door panels 8 of different thicknesses, and the spindle 55 is provided for coupling to a dead bolt 88 (FIG. 1) for actuating the dead bolt 88 to engage with the door frame 80 or for disengaging the dead bolt 88 from the door frame 80. The rotary member 50 includes a notch 59 formed therein (FIG. 6) and communicating with the hole 54 of the rotary member 50.

A latch member 60 is slidably attached to the notch 59 of the rotary member 50 and movable radially relative to the rotary member 50 along the radially extended channel 53 of the rotary member 50, and the latch member 60 is engageable with the noncircular end 56 of the spindle 55 for selectively coupling the rotary member 50 and the spindle 55 together and for allowing the spindle 55 to be selectively rotated or driven by the rotary member 50. One or more (such as two) spring members 61 are disposed or engaged between the latch member 60 and the rotary member 50 for biasing or forcing the latch member 60 away from the noncircular end 56 of the spindle 55. The latch member 60 may further include a rod 62 (FIGS. 2, 6) extended outwardly therefrom for slidably engaging with the radially extended channel 53 of the rotary member 50, and for guiding and limiting the latch member 60 to slide or move radially relative to the rotary member 50 and for preventing the latch member 60 from being disengaged from the rotary member 50.

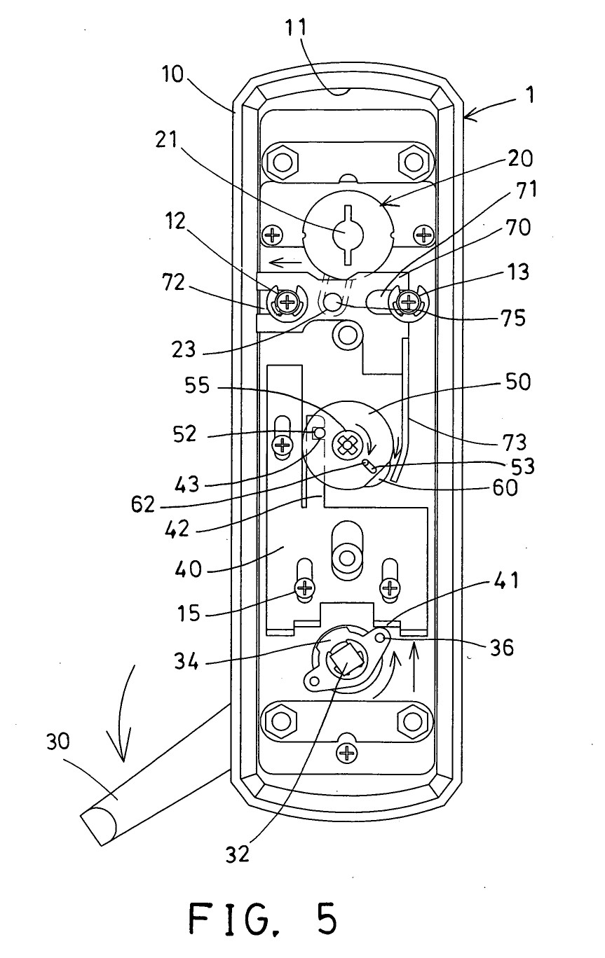

A follower 70 is slidably attached to the housing 10 and disposed in the chamber 11 of the housing 10 and includes two slots 71, 72 formed therein for slidably receiving or engaging with the stops 12, 13 of the housing 10 and for guiding and limiting the follower 70 to slide or move laterally relative to the housing 10, and includes an actuating finger 73 extended outwardly therefrom and movable toward and away from the latch member 60 for selectively engaging with the latch member 60 and for selectively forcing or actuating the latch member 60 toward and to engage with the spindle 55 (FIG. 5) and for allowing the spindle 55 to be selectively rotated or driven by the rotary member 50, and thus for allowing the dead bolt 88 to be selectively moved or actuated or operated by the actuating lever 30. The follower 70 includes a projection 75 extended outwardly therefrom and coupled to the exterior lock device 20 with a link 23 for allowing the follower 70 to be moved selectively and laterally relative to the housing 10 by the exterior lock device 20.

In operation, as shown in FIG. 4, when the exterior lock device 20 is locked, the follower 70 may be moved laterally relative to the housing 10 by the exterior lock device 20 to disengage or to move the actuating finger 73 from the rotary member 50 and the latch member 60, and for allowing the latch member 60 to be biased outwardly relative to the rotary member 50 by the spring members 61 and to be biased and forced to move away from the noncircular end 56 of the spindle 55, for preventing the dead bolt 88 and the spindle 55 from being operated or actuated by the actuating lever 30, and for allowing the actuating lever 30 to be rotated freely relative to the housing 10 without operating or actuating the spindle 55 and the dead bolt 88.

As shown in FIG. 5, when the exterior lock device 20 is unlocked, the follower 70 may be moved laterally relative to the housing 10 again by the exterior lock device 20 to move the actuating finger 73 to engage with the rotary member 50 and the latch member 60, and for allowing the latch member 60 to be forced and moved into the rotary member 50 by the actuating finger 73 and to be biased and forced to engage with the noncircular end 56 of the spindle 55, and thus to allow the dead bolt 88 and the spindle 55 to be operated or actuated by the actuating lever 30. Accordingly, it is to be noted that the dead bolt 88 and the spindle 55 may not be operated or actuated by the actuating lever 30 when the exterior lock device 20 is locked, such that the connecting mechanism, including the handle shaft 32, the slide plate 40, the rotary member 50, and the spindle 55 that are coupled or connected between the dead bolt 88 and the actuating lever 30 may not be brutally or forcedly rotated or actuated or damaged by the actuating lever 30 and/or by the unauthorized persons.

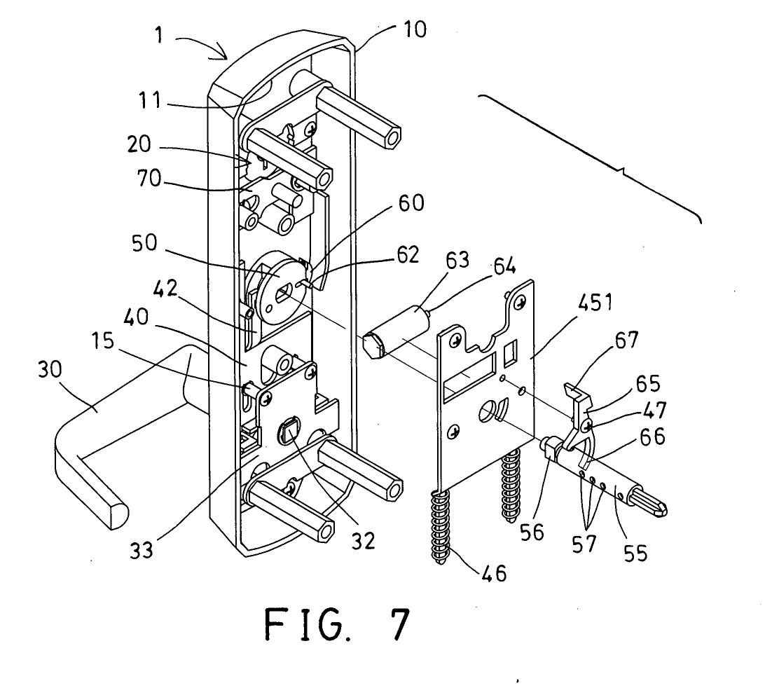

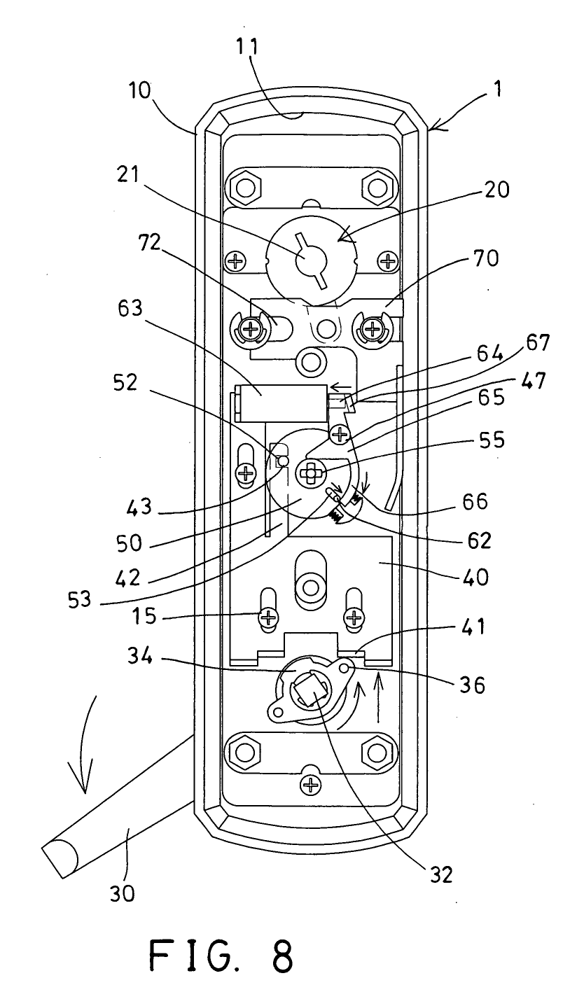

Alternatively, as shown in FIGS. 7 and 8, an electromagnetic device 63 may be attached or mounted to the cover plate 451, and includes a plunger 64 slidably attached or engaged therein, and another follower 65 may be pivotally or rotatably coupled or attached or mounted to the cover plate 451 with a pivot axle 47, and includes an actuating finger 66 for selectively engaging with the rod 62 of the latch member 60 and for selectively forcing or actuating the latch member 60 toward and to engage with the spindle 55 and for allowing the spindle 55 to be selectively rotated or driven by the rotary member 50, and thus for allowing the dead bolt 88 to be selectively moved or actuated or operated by the actuating lever 30. The other end 67 of the follower 65 may be engaged with the plunger 64 of the electromagnetic device 63 which may thus be provided to rotate the follower 65 and to selectively force or actuate the latch member 60 toward and to engage with the spindle 55 when required.

Accordingly, the safety door lock in accordance with the present invention includes an actuating lever freely rotatable and disconnected from the dead bolt when the latch shaft of the lock device is locked for preventing the dead bolt and the connecting mechanism from being damaged by the actuating lever brutally or forcedly and/or from being brutally or forcedly damaged by the unauthorized persons.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door lock comprising:
a housing including a chamber formed therein,
a lock device attached to said housing,
an actuating lever rotatably attached to said housing and including a noncircular orifice formed therein for engaging with a handle shaft and for rotating said handle shaft,
a rocker arm engaged with said handle shaft and to be rotated and driven by said handle shaft and said actuating lever,
a slide plate slidably attached to said housing and engaged with said rocker arm and moveable relative to said housing by said rocker arm,
a rotary member rotatably mounted to said housing and connected to said slide plate for allowing said rotary member to be rotated relative to said housing by said slide plate and said rocker arm and said handle shaft and said actuating lever,
a spindle rotatably attached to said housing and engaged with said rotary member,
a latch member slidably attached to said rotary member and movable relative to said rotary member and engageable with said spindle for selectively coupling said spindle to said rotary member and for allowing said spindle to be selectively rotated by said rotary member, and
a follower disposed in said housing and including an actuating finger movable toward and away from said latch member for selectively forcing and actuating said latch member to engage with said spindle and for allowing said spindle to be selectively rotated by said rotary member when said latch member is engaged with said spindle, and for preventing said spindle from being rotated by said rotary member when said latch member is disengaged from said spindle.

2. The door lock as claimed in claim 1, wherein said rotary member includes a spring member engaged between said latch member and said rotary member for biasing said latch member away from said spindle.

3. The door lock as claimed in claim 1, wherein said rotary member includes a channel formed therein, and said latch member includes a rod extended outwardly therefrom and slidably engaged with said channel of said rotary member for guiding and limiting said latch member to slide and to move relative to said rotary member.

4. The door lock as claimed in claim 1, wherein said rotary member includes a center hole formed therein, and said spindle includes a noncircular end rotatably engaged with said center hole of said rotary member for selectively engaging with said latch member.

5. The door lock as claimed in claim 1, wherein said slide plate includes an anchoring portion provided therein, and said rotary member includes an actuator engaged with said anchoring portion of said slide plate for connecting said rotary member to said slide plate and for allowing said rotary member to be rotated relative to said housing by said slide plate and said rocker arm and said handle shaft and said actuating lever.

6. The door lock as claimed in claim 1, wherein said housing includes a cover plate, and a spring member engaged between said cover plate and said slide plate for biasing and forcing said slide plate to engage with said rocker arm.

7. The door lock as claimed in claim 1, wherein said housing includes at least one guide pin extended into said chamber of said housing, and said slide plate is slidably attached to said at least one guide pin of said housing and limited to slide and to move relative to said housing by said at least one guide pins.

8. The door lock as claimed in claim 1, wherein said follower is slidably attached to said housing and disposed in said chamber of said housing.

9. The door lock as claimed in claim 8, wherein said housing includes at least one stop, and said follower includes at least one slot formed therein for slidably receiving and engaging with said at least one stop of said housing and for guiding and limiting said follower to slide and to move relative to said housing.

10. The door lock as claimed in claim 1, wherein said follower includes a projection extended therefrom and coupled to said lock device with a link for allowing said follower to be selectively moved relative to said housing by said lock device.

11. The door lock as claimed in claim 1, wherein said spindle includes a plurality of cavities formed therein for engaging with an anchor which adjustably anchor and secure said spindle to a door panel.
